(19) United States
(12) Patent Application Publication
(10) Pub. No.: US 2015/0368515 A1
(43) Pub. Date: Dec. 24, 2015

(54) CMP SLURRY COMPOSITIONS AND METHODS FOR ALUMINUM POLISHING

(71) Applicant: Cabot Microelectronics Corporation, Aurora, IL (US)

(72) Inventors: Lung-Tai Lu, Tainan (TW); Wen-Cheng Liu, Kaohsiung (TW); Jiu-Ching Chen, Kaohsiung (TW)

(21) Appl. No.: 14/743,583

(22) Filed: Jun. 18, 2015

Related U.S. Application Data
(60) Provisional application No. 62/015,084, filed on Jun. 20, 2014.

(51) Int. Cl. C09G 1/02; C23F 3/03

(52) U.S. Cl. CPC C09G 1/02; C23F 3/03

(57) ABSTRACT

Chemical-mechanical polishing (CMP) compositions and methods are described, which are suitable for polishing an aluminum surface. The compositions comprise alumina abrasive particles coated with an anionic polymer, and suspended in an acidic or neutral pH carrier. In some cases, a polishing aid such as silica, a carboxylic acid, a phosphonic acid compound, or a combination thereof may be added to the CMP compositions. The described CMP compositions and methods improve polishing efficacy and reduce surface imperfections on a polished aluminum surface compared to CMP methods using uncoated alumina abrasive.

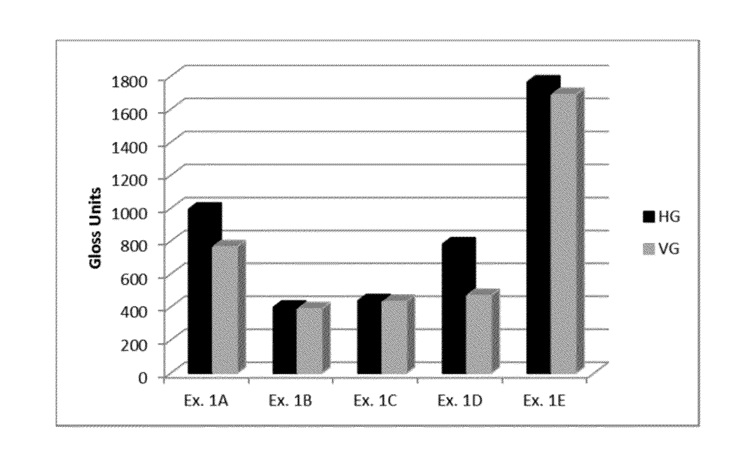

### CROSS-REFERENCE TO A RELATED APPLICATION

This patent application claims the benefit of U.S. Provisional Patent Application No. 62/015,084, filed Jun. 20, 2014, which is incorporated by reference in its entirety herein.

### FIELD OF THE INVENTION

This invention relates to polishing compositions and methods for polishing an aluminum alloy. More particularly, this invention relates to chemical-mechanical polishing compositions and methods utilizing an alumina abrasive coated with a polymer for polishing an aluminum surface to a high quality, mirror finish.

### BACKGROUND OF THE INVENTION

Aluminum is commonly used as the conductive material forming wirings and/or conductive plugs in semiconductor devices, and is also used to create metallic mirrors, casings and other parts or elements for various devices and articles of manufacture. Aluminum and aluminum alloys can also be deposited in a layer to create decorative coatings for surfaces of a variety of industrial and consumer products, including e.g., housings for machinery, mobile phones, tablet computers, laptop computers, and other devices. Aluminum is a suitable metal for these applications due to its high reflectivity, light weight, low cost, and compatibility with conventional surface forming processes. As used herein, the term “aluminum” is inclusive of pure aluminum metal and of aluminum alloys in which aluminum is the main component.

Decorative surfaces or mirror surfaces comprising aluminum are traditionally formed by applying a metallic coating of aluminum (or an aluminum alloy) to a substrate composed of another metal or of another material such as glass. The deposited aluminum typically is then polished to eliminate or reduce the topographical variations and defects. The surface may then be anodized or polished to a desired degree of gloss, depending on the intended use. In other cases, the surface of an entirely aluminum substrate may need to be polished to a high gloss. When high gloss or reflectivity is desired, the aluminum surface preferably is polished to a gloss of greater than about 1700 GU (gloss units) to create a commercially desirable decorative finish.

Chemical-mechanical polishing or planarization (CMP) has long been used in the electronics industry to polish or planarize the surface of deposited layers. Typically, the deposited layer is planarized by a CMP process to reduce surface roughness, but CMP may produce microscratches and leave imbedded abrasive particles on the polished surface. CMP can also be utilized to polish substrates (e.g. metal or glass) with deposited coatings.

In a CMP process, the substrate to be polished is contacted and abraded with a CMP composition comprising abrasive particles in a liquid carrier. A polishing pad coated with the CMP composition generally is used to aid in mechanically abrading the surface of the substrate. The polishing of the substrate surface typically is further aided by the chemical activity of the polishing composition (e.g., by oxidizing agents or other additives present in the CMP composition). Typical abrasive materials include, for example, silicon dioxide (silica), cerium oxide (ceria), aluminum oxide (alumina), zirconium oxide (zirconia), titanium dioxide (titania), and tin oxide.

Pure aluminum is a relatively soft material with a Mohs hardness of 2.75. As such, use of conventional polishing abrasives may result in scratches or other imperfections on the aluminum surface. For example, the use of conventional polishing abrasives to polish aluminum can result in under polishing, fogging, orange peeling, corrosion, and slurry residue contamination on the polished aluminum surface. In addition, aluminum surfaces can be readily oxidized to impart a thin layer of aluminum oxide to the surface. Aluminum oxide is considerably harder than metallic aluminum, and formation of the oxide can affect polishing rates.

There remains a need for efficient and economical methods of polishing aluminum surfaces to exacting standards of surface roughness suitable to create a desirable, high gloss finish. The methods and CMP compositions described herein address this need. These and other advantages of the invention, as well as additional inventive features, will be apparent from the description of the invention provided herein.

### SUMMARY OF THE INVENTION

The present invention provides chemical-mechanical polishing (CMP) compositions and methods suitable, e.g., for polishing an aluminum surface, particularly an aluminum alloy surface.

The CMP compositions of the invention comprise a neutral or acidic aqueous carrier containing alumina abrasive particles that comprise an anionic polymer on the surface of the alumina abrasive particles. Preferably, a polishing aid is included in the composition, e.g., a polishing aid selected from the group consisting of silica abrasive (e.g., fumed silica, colloidal silica, or a combination thereof), a polishing promoter compound, and a combination thereof. The polishing promoter compound comprises, consists essentially of, or consists of at least one organic acid, at least one inorganic acid, or a combination thereof. In some embodiments, the polishing promoter compound is selected from the group consisting a carboxylic acid, an organophosphonic, an organosulfonic acid, sulfuric acid, phosphoric acid, phosphorous acid, and a combination thereof. In some embodiments, the organic acid comprises a methylene or ethylidene moiety bearing two carboxylic acid groups or two phosphonic acid groups, such as malonic acid, succinic acid, 1-hydroxyethylidene-1,1-diphosphonic acid (HEDP), and the like. Preferably, the CMP composition does not contain an oxidizing agent such as hydrogen peroxide.

The alumina generally is present in the composition at a concentration in the range of about 0.01 wt % to about 15 wt %, more preferably about 0.05 wt % to about 10 wt %. Typically, the alumina has a mean particle size in the range of about 50 nm to about 1000 nm (e.g., about 100 to 500 nm, such as 100-110, 350, and 500 nm) The primary abrasive particles generally have a particle size in the range of 100 to 110 nm.

In some embodiments the anionic polymer is e.g., poly(2-acrylamido-2-methylpropane sulfonic acid) (AMPS), acrylic acid-2-acrylamido-2-methylpropane sulfonic acid copolymer (AA/AMPS), polystyrenesulfonic acid, or a combination of two or more thereof. The polymer is present to impart a negative charge to the alumina particle surface, which can provide electrostatic attraction to the generally positive charge of the aluminum surface being polished under the acidic polishing conditions utilized in the present methods. U.S. Pat. No. 8,425,797 provides a detailed description of coating alumina with an anionic polymer to impart a negative charge thereto, and is incorporated herein by reference in its entirety. Generally, the weight ratio of the polymer to the alumina will be about 0.01 to about 3 (e.g., not less than about 0.05, 0.10, or 0.20, and not more than about 1 or about 2).

In some embodiments, the polishing promoter compound is selected from the group consisting of a methylene or ethylene moiety bearing two carboxylic acid groups or two phosphonic acid groups (e.g., 1-hydroxyethylidene-1,1-diphosphonic acid, malonic acid, tartaric acid, oxalic acid), lactic acid, camphorsulfonic acid, toluenesulfonic acid, formic acid, sulfuric acid, phosphoric acid, phosphorous acid, and a combination thereof. The polishing promoter compound, when utilized, generally is present in the CMP composition at a concentration in the range of about 0.01 wt % to about 5 wt. %, e.g., about 0.05 wt. % to about 3 wt. % at point of use.

In some embodiments, the polishing aid comprises colloidal silica, fumed silica or a combination thereof, e.g., a silica having a mean particle size in the range of about 50 nm to about 200 nm. The silica abrasive, when utilized, typically is present in the CMP composition at a concentration in the range of about 0.1 wt. % to about 15 wt. %, e.g., about 1 wt. % to 5 wt. % at point of use.

The polishing compositions and methods described herein provide surprisingly higher gloss aluminum surfaces, with surprisingly lower levels of surface defects compared to aluminum polished with silica alone or uncoated alumina abrasive alone.

### BRIEF DESCRIPTION OF THE DRAWINGS

The FIGURE provides a graph of surface gloss (horizontal gloss, HG, as well as vertical gloss, VG) for aluminum alloy surfaces polished with various abrasives.

### DETAILED DESCRIPTION OF THE INVENTION

The invention provides a composition for polishing a surface of an object comprising aluminum. Preferably, the aluminum comprises an aluminum alloy. Numerous aluminum alloys are commercially available that are individually characterized by the presence of various elements in addition to aluminum and by the particular processes used in their production. Aluminum alloys are further subdivided into foundry alloys and wrought alloys, wherein foundry alloys are intended for use in molding processes employing the molten alloys, and wrought alloys are intended for use in mechanical shaping processes of the solid alloys. Wrought alloys are often further heat-treated to modify mechanical properties (e.g., hardness) of the alloys. Any aluminum alloy is suitable for use in the inventive composition method, although some aluminum alloys are particularly suited for the inventive composition and method. The composition is acidic or neutral in pH and typically comprises an alumina abrasive with an anionic polymer and a polishing aid such as a silica abrasive, an organic acid, an inorganic acid, or a combination of two or more thereof. The polishing composition preferably is free from oxidizing agents such as hydrogen peroxide.

In some embodiments, the surface to be polished comprises an aluminum alloy of the 6000 series or 7000 series. The term “6000 series” refers to the Aluminum Association designation of a particular group of aluminum alloys that include magnesium and silicon, among other additives. The 6000 series exhibits high corrosion resistance, excellent extrudability, and moderate strength. The term “7000 series” refers to the Aluminum Association designation of a particular group of aluminum alloys that include zinc, among other additives. The 7000 series exhibits very high strength and toughness. Aluminum alloys of the 6000 series are softer than 7000 series aluminum alloys.

Although the CMP compositions and methods described herein may be used to polish aluminum alloys in a variety of substrates, devices and applications. The methods and compositions are particularly well-suited for polishing aluminum alloys deposited on the surface housings, shells, or casings of devices where decorative features may be desired, e.g., personal electronic devices. The polishing of aluminum alloy provides highly stylized mirror-like decorative surface where desired. The polishing step can be utilized on the entire surface of a substrate or just on portions thereof, depending upon the design specifications of the substrate.

For example, a substrate or a large portion of the substrate can be formed from aluminum (e.g., an aluminum alloy), and the aluminum substrate can be machined into a desired shape or configuration. Alternatively or in addition, the aluminum can be coated onto another substrate (e.g., another metal). The aluminum surface is then polished by a series of coarse polishing steps followed by a series of fine polishing steps. In some cases, multiple finishes may be applied to the substrate. In such cases, the aluminum is polished, and then areas of the substrate that will ultimately have a mirror-like appearance (such as logos, wording or other features) can be masked with a protective film. The un-masked areas of the casing can them be further processed or treated (e.g. by a coating or anodizing) to create a desired visual effect in those areas, while maintaining the highly-polished aluminum surface under the protective film. The protective film can then be removed to reveal the mirror-like surface in the formerly masked portions of the substrate. Both 6000 series and 7000 series aluminum alloys are well suited for obtaining high gloss surfaces.

In view of the relatively soft surface of aluminum and alloys thereof and the sensitivity of aluminum to oxidation, some particulate abrasives and polishing conditions useful in conventional CMP may be inappropriate for polishing aluminum without some modification of the CMP slurry formulation. For example, CMP compositions using colloidal silica or fumed silica as a particulate abrasive often have a relatively high pH value (e.g. around 10). This high pH environment can create corrosion defects on the aluminum surfaces, depending on the polishing conditions used. Alumina abrasives are relatively hard, which may create underpolishing and scratching issues on aluminum alloy surfaces. In addition, high pH can lead to surface oxidation and formation of a hard, thin layer of aluminum oxide on the surface to be polished. Thus, neutral and acidic compositions are desirable; however, acidic conditions often are not conducive to effective aluminum polishing.

The compositions and methods described herein address these issues by providing acidic or neutral CMP compositions comprising surface-modified alumina abrasive particles, and in some embodiments, including specific polishing aids (e.g. silica abrasive or particular polishing promoter compounds) to provide surprisingly reliable and reproducible high gloss aluminum surfaces at reasonable polishing rates, with low defectively. The CMP compositions utilized in the methods described herein preferably are free from oxidizing agents such as hydrogen peroxide.

Examples of the potential defects created in the surface of aluminum alloy when prior art compositions containing colloidal silica abrasive include, for example, under-polish, orange peel (rough grainy surface), white spots, voids, surface corrosion, organic residue, scratches, and fogging.

Particulate abrasives useful in the CMP compositions of the invention include an alumina particles treated with a polymer to modify the surface properties of the abrasive. For example, an alumina abrasive coated with an anionic polymer on the surface of the alumina particles is particularly advantageous for use in the CMP compositions of the invention. The coated alumina abrasive particles of the invention have a negative charge consistent across a wide pH range from, for example, about pH 2 to about pH 9. It is believed that the negative charge imparted to the alumina particles results in attraction of the abrasive to the positive surface of the aluminum. This electrostatic attraction is believed to lead to higher polishing removal rates and less surface defects when the coated alumina abrasive is used to polish the aluminum instead of uncoated alumina abrasive or silica abrasive. In order for uncoated alumina abrasive to have a significant negative zeta potential, the pH of the composition must be raised to around pH 11. A pH of about 7.5 is required for a silica abrasive to have a suitable negative charge. The basic pH required for these silica abrasive and untreated alumina abrasives to reach a desirable negative charge results in surface imperfections and deformities. For example, a composition with a high pH value of about 10 creates corrosion imperfections and does not achieve a desirably high gloss finish (e.g., greater than 1600 Gloss Units (GU)) for a polished aluminum surface.

The anionic polymer can be a polymer having multiple acid groups (e.g., multiple carboxylic acid, sulfonic acid groups, or a combination thereof, on an organic polymer backbone, which can be a hydrocarbon backbone, a polyamide backbone, a polyether backbone, or a combination thereof. In some embodiments the anionic polymer is e.g., poly(2-acrylamido-2-methylpropane sulfonic acid) (AMPS), acrylic acid-2-acrylamido-2-methylpropane sulfonic acid copolymer (AA/AMPS), polystyrenesulfonic acid, or a combination of two or more thereof. Preferably, the anionic polymer is present in the composition at a concentration sufficient to impart a negative charge to the alumina particles. e.g., as described in U.S. Pat. No. 8,425,797, referred to and incorporated by reference above. Generally the weight ratio of the polymer to the alumina will be about 0.01 to about 3 (e.g., not less than about 0.05, 0.10, or 0.20, and not more than about 1 or about 2).

Typically, the alumina abrasive used in the CMP compositions of the invention have a mean particle size in the range of about 50 nm to about 1000 nm, more preferably about 75 nm to about 500 nm (e.g., about 90 to 400 nm, such as 100, 110, 120, 150, 200, 250, 350, and 400 nm). The typical concentration of alumina abrasive in the composition is about 0.01 wt % to about 15 wt %, more preferably about 0.05 wt % to about 10 wt % (e.g. about 0.1 wt. % to about 5 wt. %, about 0.5 wt. % to about 4 wt. %).

The polishing properties of the coated alumina abrasive CMP composition of the invention can be further enhanced by including a polishing promoter compound. The polishing promoter compound comprises one or more acids organic acid, one or more inorganic acid, or a combination of one or more organic acid and one or more inorganic acid (e.g., an acid selected from the group consisting of 1-hydroxyethylidene-1,1-diphosphonic acid, malonic acid, oxalic acid, lactic acid, tartaric acid, camphorsulfonic acid, toluenesulfonic acid, formic acid, sulfuric acid, phosphoric acid, phosphorous acid, or a combination of two or more thereof). The inclusion of the polishing promoter is believed to improve the removal rate and decrease imperfections on the polished aluminum alloy surface.

Non-limiting examples of suitable organic acids include carboxylic acids (e.g., formic acid, acetic acid, lactic acid, malonic acid, and the like), organophosphonic acids, preferably having 1 to 8 carbon atoms in the organic portion thereof (e.g., amino-tri(methylene phosphonic acid), 1-hydroxyethylidene-1,1,-diphosphonic acid (“HEDP) and the like), organosulfonic acids preferably having 1 to 12 carbon atoms in the organic portion thereof (e.g., methanesulfonic acid, benzenesulfonic acid, toluenesulfonic acid, camphorsulfonic acid, and the like), and organic acids comprising a combination of moieties selected from a carboxylic acid, a phosphonic acid, and a sulfonic acid (e.g., sulfosuccinic acid, 2-phosphonobutane-1,2,4-tricarboxylic acid, 2-[(phosphonomethyl)amino]acetic acid, 2-carboxyethylphosphonic acid, and the like). Non-limiting examples of suitable carboxylic acids include carboxylic acids comprising 1 to 12 carbon atoms, 1 to 10 carbon atoms, or 1 to 8 carbon atoms, e.g., a monocarboxylic acid such as formic acid, acetic acid, propanoic acid, lactic acid, benzoic acid, and the like; a dicarboxylic acid such as malonic acid, succinic acid, maleic acid, fumaric acid, tartaric acid, a phthalic acid, and the like; and a tricarboxylic acid such as citric acid and the like; as well as a combination of two or more such carboxylic acids. In some embodiments, the organic acid comprises a methylene or ethylidene moiety bearing two carboxylic acid groups or two phosphonic acid groups, such as malonic acid, succinic acid, HEDP, and the like.

Non-limiting examples of suitable inorganic acid polishing promoter compounds include sulfuric acid, phosphoric acid, phosphorous acid, and a combination of two or more thereof.

The surprisingly improved polishing performance obtained with the polishing promoter compounds may, in part, be the result of a reduction in the polishing pad temperature that occurs during the polishing process when the polishing promoters are present in the composition. The friction created during a conventional polishing process with uncoated alumina abrasive generally results in the polishing pad temperature reaching around 40° C. Inclusion of the polishing promoters in the CMP composition surprisingly results in the polishing pad temperature of only about 30° C. This decreased pad temperature may result in reduced surface defects and imperfections that can occur during polishing at higher temperatures. For example, higher pad temperature tends to accelerate pad wear, and worn polishing pads increase surface imperfections. Higher pad temperatures also increase the amount of organic residues that are deposited on the substrate surface during polishing, because the aqueous portion of the composition evaporates more quickly at higher temperature, leaving solid components of the composition dried to the substrate surface. Increased organic residue leads to undesirable substrate corrosion and fog. Typically, the concentration of the polishing promoter compound, optionally included in the composition, is about 0.01 wt % to about 5 wt %, e.g., about 0.05 wt % to about 3 wt % at point of use.

The polishing properties of the coated alumina abrasive also can be enhanced by including silica abrasive in the composition as a polishing aid. The silica abrasive works together with the coated alumina abrasive to create a synergistic effect and improve the polishing results. In one preferred embodiment, the silica abrasive is colloidal silica. In another preferred embodiment, the silica abrasive is fumed silica. Generally, the silica abrasive has a mean particle size in the range of about 50 nm to about 200 nm. The typical concentration of silica abrasive, when used as a polishing aid, is about 0.1 wt % to about 15 wt %, more preferably about 0.3 wt % to about 10 wt %, e.g., about 1 wt % to about 5 wt % at point of use.

The polishing compositions of the present invention also can be provided as a concentrate, which is intended to be diluted with an appropriate amount of aqueous solvent prior to use (at point of use). In such an embodiment, the polishing composition concentrate can include the various components dispersed or dissolved in aqueous solvent in amounts such that, upon dilution of the concentrate with an appropriate amount of aqueous solvent (e.g., water) each component of the polishing composition will be present in the polishing composition in an amount within the appropriate range for use.

The CMP compositions of the present invention are particularly suited for use in conjunction with a chemical-mechanical polishing apparatus, although any polishing apparatus adapted for use with liquid abrasives can be used in the methods described herein. Typically, the CMP apparatus comprises a platen, which, when in use, is in motion and has a velocity that results from orbital, linear, and/or circular motion. A polishing pad is mounted on the platen and moves with the platen. A carrier assembly holds a substrate to be polished in contact with the pad and moves relative to the surface of the polishing pad, while urging the substrate against the pad at a selected pressure (down force) to aid in abrading the surface of the substrate. A CMP composition (or slurry) is pumped onto the polishing pad to aid in the polishing process. The polishing of the substrate is accomplished by the combined abrasive action of the moving polishing pad and the CMP composition of the invention present on the polishing pad, which abrades at least a portion of the surface of the substrate, and thereby polishes the surface.

The methods and apparatus of the present invention can utilize any suitable polishing pad (e.g., polishing surface). Non-limiting examples of suitable polishing pads include woven and non-woven polishing pads, which can include fixed abrasives, if desired. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, coformed products thereof, and mixtures thereof. In a preferred method of the invention, the polishing pad that is used is an extruded thermoplastic pad sold under the trade name EPIC D100, available from Cabot Microelectronics Corporation (Aurora, Ill.).

The non-limiting examples discussed below further illustrate certain aspects of the compositions and methods of the present invention.

### Example 1

This example illustrates the use of a variety of compositions containing different abrasive particles for polishing aluminum.

Series 6061 aluminum alloy substrates were polished with a variety of abrasive materials for 15 minutes on a GnP POLI-500 polishing device, (G&P Technology, Inc. Busan, South Korea) fitted with an EPIC D100 polishing pad (Cabot Microelectronics Corporation, Aurora, Ill.). The polishing parameters were; a platen speed of about 80 rpm, a head speed of about 74 rpm, a down pressure of about 2.0 psi, and a slurry flow rate of about 100 mL/minute.

Various CMP compositions were prepared, which had the formulations shown in Table 1. The compositions were utilized to polish the aluminum alloy substrates for about 15 minutes as described above.

TABLE 1

| Example | |
|---|---|
| Composition | Formulation |
| 1A | 40% colloidal silica (100 nm average particle size), pH 10 |
| 1B | 40% colloidal silica (117 nm average particle size), pH 10 |
| 1C | 23% fumed silica (110 nm average particle size), pH 10 |
| 1D | 1% alpha-alumina (uncoated; 100 nm average particle size), |
| | pH 3 |
| 1E | 1% alpha-alumina (coated; 100 nm average particle size)*, |
| | pH 3 |

*alumina abrasive particles surface-coated with poly(2-acrylamido-2-methylpropane sulfonic acid)

The results of the aluminum alloy polishing using the various composition of Table 1 are summarized in Table 2 and the FIGURE. The pH column in Table 2 indicates the pH of the composition used during the CMP process. The HG column indicates the horizontal gloss value (in Gloss Units, GU) of the polished substrate. The VG column indicates the vertical gloss value (in GU) of the polished substrate. The RR column indicates the aluminum alloy removal rate (in micrometers removed over the 15 minute polishing process). The appearance column indicates surface characteristics present on the polished surface upon visual inspection.

TABLE 2
Polishing Results.

| Composition | Abrasive | pH | HG | VG | RR | Appearance |
|---|---|---|---|---|---|---|
| 1A | colloidal silica | 10 | 996 | 766 | low | under polished |
| 1B | colloidal silica | 10 | 400 | 391 | low | under-polished |
| 1C | fumed silica | 10 | 439 | 436 | 4.2 | scratched |
| 1D | alumina | 3 | 783 | 472 | low | under-polished; |
| | | | | | | scratched; |
| | | | | | | voids present |
| 1E | coated alumina | 3 | 1766 | 1690 | 1.2 | smooth |

As is evident from the data in Table 2 and the FIGURE, the coated alumina abrasive provided a desirably smooth appearance with high vertical and horizontal gloss compared to the silica abrasive and uncoated alumina abrasive.

### Example 2

This example illustrates the use of anionic polymer-coated alumina abrasive for polishing aluminum alloy. The coated alumina abrasive of Example 1E was utilized to polish 6063 aluminum alloy substrates. A composition was prepared from a 12 wt. % stock suspension of the abrasive at a pH of about 3 to 5, diluted (3×) with deionized water to achieve a final abrasive concentration of about 4 wt. %. The composition was used to polish the aluminum alloy substrates on a CMP apparatus polishing device fitted with a polishing pad, as set forth in Example 1. The polishing parameters were; a platen speed of about 80 rpm, a head speed of about 74 rpm, a down pressure of about 2.0 psi, and a slurry flow rate of about 100 mL/minute. Upon visual inspection, the polished surface was of better quality than was obtained with an identical polishing composition, but using an uncoated alumina abrasive at 1 wt % concentration. Visual inspection of the polished surface revealed the existence of some scratch and under polish defects, however. These defects are believed to have occurred due to the relatively high polishing temperature of >40° C. that was observed.

### Example 3

This example illustrates the use of a CMP composition containing the coated alumina abrasive of Example 1 (1 wt. %) in combination with 1-hydroxyethylidene-1,1-diphosphonic acid (0.3 wt. %) as a polishing promoter.

The CMP composition was used to polish 6063 aluminum alloy substrates using the same CMP equipment and conditions as described in Example 1. Visual inspection of the polished surface revealed better surface quality than observed in Example 2 for the coated-alumina abrasive alone. The surface polished according to this example exhibited no under-polish, minimal scratching, and no other visible defects. While not wishing to be bound by theory, it is believed that the improvements in the polished surface may be the result of a lower polishing pad temperature that results from the use of the polishing promoter compound.

### Example 4

This example illustrates the use of CMP compositions containing the coated alumina abrasive of Example 1 in combination with fumed silica of Example 1C or colloidal silica as a polishing aid. A first composition was prepared from a stock suspension of 3 wt. % coated aluminum abrasive and 3 wt. % fumed silica abrasive, by dilution (3×) with deionized water to achieve a total solids level of about 2 wt. % (1 wt. % alumina, 1 wt. % silica). A second composition was prepared from 1.5 wt. % coated alumina abrasive and 15 wt. % colloidal silica abrasive, by dilution (3×) with deionized water to achieve a total solids level of about 5.5 wt. % (0.5 wt. % alumina, 5 wt. % silica).

The CMP compositions were used to polish 6063 aluminum alloy substrates using the same CMP method described in Example 1. Visual inspection of the polished wafers revealed that the polished surfaces were of better quality than observed in Example 2 and comparable to Example 3. The surfaces polished according to this example exhibited no under-polish, minimal scratching, and no other visible defects.

All references, including publications, patent applications, and patents, cited herein are hereby incorporated by reference to the same extent as if each reference were individually and specifically indicated to be incorporated by reference and were set forth in its entirety herein. The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of polishing an aluminum surface comprising a step of abrading the surface with a polishing composition comprising an acidic or neutral pH aqueous carrier containing:
(a) alumina abrasive particles comprising an anionic polymer on the surface of the alumina particles; and
(b) a polishing aid selected from the group consisting of silica abrasive, a polishing promoter compound, and a combination thereof;
wherein the polishing promoter compound is an organic acid, an inorganic acid, or combination thereof.

2. The method of claim 1, wherein the aluminum surface comprises substantially pure aluminum, or aluminum alloyed with an element selected from the group consisting of Cu, Mn, Si, Mg, Zn, and a combination of two or more thereof.

3. The method of claim 1, wherein the polishing promoter compound comprises an organic acid comprising a methylene or ethylidene moiety bearing two carboxylic acid groups or two phosphonic acid groups.

4. The method of claim 1, wherein the polishing aid comprises a polishing promoter compound selected from the group consisting of 1-hydroxyethylidene-1,1-diphosphonic acid, malonic acid, oxalic acid, lactic acid, tartaric acid, camphorsulfonic acid, toluenesulfonic acid, formic acid, sulfuric acid, phosphoric acid, phosphorous acid, and a combination of two or more thereof.

5. The method of claim 1, wherein the anionic polymer comprises poly(2-acrylamido-2-methylpropane sulfonic acid), acrylic acid-2-acrylamido-2-methylpropane sulfonic acid copolymer, polystyrenesulfonic acid, or a combination of two or more thereof.

6. The method of claim 1, wherein the alumina abrasive is present in the composition at a concentration in the range of about 0.01 wt. % to about 15 wt. %.

7. The method of claim 1, wherein the polishing composition has a pH in the range of about 2 to about 7.

8. The method of claim 1, wherein the alumina abrasive has a mean particle size in the range of about 50 nm to about 1000 nm.

9. The method of claim 1, wherein the polishing aid comprises colloidal silica, fumed silica, or a combination thereof.

10. The method of claim 9, wherein the silica has a mean particle size in the range of about 50 nm to about 200 nm.

11. The method of claim 1, wherein the polishing aid comprises the polishing promoter compound at a concentration in the range of about 0.01 wt. % to about 5 wt. %, and the silica abrasive at a concentration in the range of about 0.1 wt. % to about 15 wt. %.

12. A polishing composition for polishing an aluminum surface, the composition comprising an acidic or neutral pH aqueous carrier containing:
(a) alumina abrasive particles comprising an anionic polymer on a surface of the alumina particles; and
(b) a polishing aid selected from the group consisting of silica abrasive, a polishing promoter compound, and a combination thereof;
wherein the polishing promoter compound is an organic acid, an inorganic acid, or combination thereof.

13. The polishing composition of claim 12, wherein the polishing promoter compound comprises an organic acid comprising a methylene or ethylidene moiety bearing two carboxylic acid groups or two phosphonic acid groups, 1-hydroxyethylidene-1,1-diphosphonic acid, malonic acid, oxalic acid, lactic acid, tartaric acid, camphorsulfonic acid, toluenesulfonic acid, formic acid, sulfuric acid, phosphoric acid, phosphorous acid, or a combination of two or more thereof.

14. The polishing composition of claim 12, wherein the anionic polymer comprises poly(2-acrylamido-2-methylpropane sulfonic acid) (AMPS), acrylic acid-2-acrylamido-2-methylpropane sulfonic acid copolymer (AA/AMPS), polystyrenesulfonic acid, and a combination of two or more thereof.

15. The polishing composition of claim 12, wherein the composition has a pH in the range of about 2 to about 7.

16. The polishing composition of claim 12, wherein the anionic polymer comprises poly(2-acrylamido-2-methylpropane sulfonic acid) (AMPS), acrylic acid-2-acrylamido-2-methylpropane sulfonic acid copolymer (AA/AMPS), polystyrenesulfonic acid, or a combination of two or more thereof, the alumina abrasive is present in the composition at a concentration in the range of about 0.01 wt. % to about 15 wt. %, and the alumina has a mean particle size in the range of about 50 nm to about 1000 nm.

17. The polishing composition of claim 12, wherein the polishing aid comprises the polishing promoter compound at a concentration in the range of about 0.01 wt. % to about 5 wt. %, and the silica abrasive at a concentration in the range of about 0.1 wt. % to about 15 wt. %.

18. The polishing composition of claim 12, wherein the polishing aid comprises colloidal silica, fumed silica, or a combination thereof.

19. A method of polishing an aluminum surface comprising a step of abrading the surface with a polishing composition comprising an acidic aqueous carrier containing abrasive alumina particles comprising an anionic polymer on a surface of the alumina particles, wherein the alumina abrasive particles are present in the composition at a concentration in the range of about 0.01 wt. % to about 15 wt. % during the step of abrading the surface.

20. The method of claim 19, wherein the aluminum surface comprises substantially pure aluminum, or aluminum alloyed with an element selected from the group consisting of Cu, Mn, Si, Mg, Zn, and a combination of two or more thereof.
